(19) United States
(12) Patent Application Publication
(10) Pub. No.: US 2002/0183154 A1
(43) Pub. Date: Dec. 5, 2002

(54) Drive system for a motor vehicle

(76) Inventor: Peter Ziemer, Tettnang (DE)

Correspondence Address: DAVIS & BUJOLD, P.L.L.C., 500 NORTH COMMERCIAL STREET, FOURTH FLOOR, MANCHESTER, NH, 03101, US

(21) Appl. No.: 10/112,632

(22) Filed: Mar. 28, 2002

(30) Foreign Application Priority Data
Mar. 30, 2001 (DE) 101 15 984.6

(51) Int. Cl. F16H 3/72

(52) U.S. Cl. 475/5

(57) ABSTRACT

The invention relates to a drive system for a motor vehicle powered by a drive unit (1), comprising a clutch (2) and a transmission (3) for transmitting and converting torque generated by the engine (1) to the motor vehicle's drive gear (6), wherein an electrical device (7), which can be operated as a motor, is provided as the starter. In accordance with the invention, the electrical device (7) and the engine (1) are each capable of generating torque in one rotational direction and in the opposite rotational direction. The invention further relates to a transmission (3) for such a drive system which is designed in accordance with the invention without a reversing assembly.

The invention relates to a drive system for a drive unit-powered motor vehicle, comprising a transmission and an electrical device provided as the starter, as defined in detail in the preamble to patent claim 1, and a transmission for this drive system.

A drive system for a motor vehicle is comprised of a drive unit for generating the power necessary to drive the vehicle, and a power train for transmitting this power to the vehicle's drive gear. To permit the transmission and conversion of the torque generated by the drive unit, the power train is ordinarily comprised of a clutch, which is used to disconnect or connect the flow of power between the drive unit and the output of the vehicle, a transmission, which is used to convert torque and rotational speed, a drive shaft, which transmits and relays power and a differential for dividing and relaying the flow of power.

The design possibilities for a gearbox are numerous and depend upon the type of drive of the vehicle. Common to all transmission, however, is the task of converting motor speed and motor torque, so that rotational speed and torque levels that correspond with the desired driving speeds with sufficient drive torque and/or propulsive power will reach the drive gear. Furthermore, the gearbox performs the task of enabling reverse travel by reversing the rotational direction of the drive gear. A multitude of designs exists for reversing assemblies that can be used to realize the secondary function of “reverse gear”.

Furthermore, a drive system for a motor vehicle of modern design is frequently equipped with an electrical device that is positioned in the drive system between an internal combustion engine and the transmission, and performs a starter function for the engine which is an internal combustion engine. Generally, this electrical device may also be used as the generator.

One example of such an electrical starter device is described in DE 198 17 497 A11. This electrical device serves as an external source of power or as a starter that will start up the internal combustion engine, and accelerate it to an engine speed at which a crankshaft from the internal combustion engine can be accelerated to the necessary starting speed required to start the internal combustion engine at which the internal combustion motor can continue to run on its own power.

Together with power electronics systems and a starting capacitor as the storage medium, this electrical device can be used to replace the traditional starter, the lighting dynamo and the flywheel of a motor vehicle and as generator controls the electrical power supply.

Disadvantageously, the electrical device, which is located in a manifold, elongates the drive unit. In addition, the separate electrical device, which is intended to replace the starter and the generator and is positioned between the engine and the transmission, either cannot be combined with functions of the transmission or the drive unit or can only be combined at great expense.

Nevertheless, developments are known in which this electrical device can be integrated into a partially electrical drive system or a so-called “hybrid-drive” that is equipped primarily with an internal combustion engine as its engine, making a high performance level and operating range possible for the vehicle. However, while the supplementary electrical device offers the advantages of the electric drives, such as a utilization of braking energy and emission-free operation, range and performance are limited.

Although the latter solution offers an extensive integration of the electrical device into the power train of the internal combustion engine and allows the electrical device to assume additional tasks, such as that of a starter or an on-board network generator, no significant savings in terms of space are gained, especially on the side of the transmission.

Underlying the present invention is, therefore, the objective of providing a drive system comprising a drive unit, a clutch, a transmission and an electrical device that is provided as a starter and can be operated at least as a motor; where the above-named components are designed to be multi-functional at least in part, such that the greatest possible savings in terms of space and components is attained.

In accordance with the invention, this object is attained with a drive system as specified in the characterizing features of patent claim 1 and a transmission as specified in the characterizing features of patent claim 12.

With the drive system specified in the invention, in which both the electrical device, provided as the starter and the engine, are capable of generating torque in one rotational direction and in the opposite rotational direction, both forward and reverse gears can be advantageously realized without the need of providing a mechanical reversing assembly in the transmission.

In this manner, a substantial reduction in the number of mechanical components used in the transmission and thus considerable savings in terms of space can be achieved via the simplest means. In particular with transmission designs in which the reversing assembly requires a large space, i.e., continuously variable automatic transmissions, this drive system design produces especially advantageous effects.

The space consequently saved can be utilized to reduce the structural dimensions of the transmission with a corresponding reduction in its weight and cost or to add an additional forward gear without altering the outer dimensions of the transmission.

In this, the invention simply makes use of the electrical device that is already present and functioning as the starter and can be connected to the power train shaft or positioned parallel to it. This electrical device, which can be rotated in opposite directions without technical difficulties, thus simultaneously performs the task or function of a transmission reversing assembly. This is also possible if the electrical device, which serves as the starter, is already being used for other functions, for example serving as the traveling drive or auxiliary drive, functioning as a generator for the vehicle's on-board network or serving to reclaim braking energy.

It can be provided in one advantageous embodiment that the electrical device can be operated as the motor and as the generator, thus acting as a starter-generator system. Basically any type of electrical device is suitable for this, as long as it can be operated in two different rotational directions via pole reversal, in which a direct current, alternating-current, three-phase asynchronous or three-phase synchronous device is used. Most preferred is an inverter-controlled rotating field device which is very well suited to generating higher torque levels for the crankshaft in both rotational directions.

Obviously, however, it is not imperative that the electrical device be designed as a starter-generator system; instead, it may be used merely as an electrical starter, which accelerates the crankshaft; in this case, to generate the energy needed during operation, a transitional generator with corresponding equipment can be provided.

In a configuration of the electrical device as a starter-generator system, the deceleration of the rotational motion of the engine advantageously takes place prior to a change in rotational direction via generator braking of the electrical device.

With this type of selective and highly efficient deceleration of the engine, a very rapid change in rotational direction, for example within 200 milliseconds, is possible. This allows the most rapid possible change between a reverse gear and a forward gear with a high level of security.

In one preferred embodiment, the drive unit compresses an internal combustion engine, in which a combustion chambers is bounded within a cylinder by a piston that is connected to a crankshaft drive, wherein the timing of the internal combustion engine is dependent upon information regarding the crankshaft position. Engines of this type, along with the sensor technology used to determine the crank angle, are general known; by which, on the part of th drive unit, only minor adaptations are of existing internal combustion engines are required for use with the drive system specified in the invention.

The activation of the internal combustion engine preferably takes place as a function of an activation diagram, in which the processes within the combustion chamber are plotted in the form of a circle, based upon the degree of crankshaft rotation, wherein the axis between upper dead center and lower dead center for the piston represents a mirror axis; mirror-inverted to which the activation of the processes in the combustion chamber takes place when the rotational direction of the crankshaft is changed.

In one particularly preferred embodiment of the invention, when the internal combustion engine is disengaged for reversing the direction of rotation, a ring-back transpiring on the crankshaft in the opposite rotational directions is utilized to accelerate the reversal in rotational direction.

It was recognized that in internal combustion engines with conventional valve gear, when the engine is being disengaged, depending upon the position of the crankshaft at the time the engine is disengaged, a damped rotary oscillation of the crankshaft around the zero rotational speed line occurs as a result of compression and decompression. Measurement results shows that in this process, the internal combustion engine is accelerated in the opposite rotational direction, i.e., in reverse, at speeds of up to ca. 150 rpm, within tenths of a second. The reverse motion of the crankshaft, which is already present in traditional drive systems, is now utilized by the invention to support the starter motor in the reversal of rotational direction. In this way, an acceleration of the change in rotational direction is advantageously achieved.

In order to optimally utilize this “swing back” effect, the activation of the processes in the combustion chamber and the electrical device serving at least as a starter are preferably synchronized with one another such that the crankshaft passes through the rotational speed zero line at a defined angular position.

This synchronization produces particularly favorable results when the crankshaft passes through the rotational speed zero line at the point of maximum pressure build-up in the combustion chamber, since at this operating point the greatest “swing back” effect, i.e., the maximum potential energy that can be converter to kinetic energy, is present.

However, the exploitation of pressure energy need not be used for conversion into kinetic energy with in a reversal in rotational direction. If, for example, the driver chooses to continue driving in the same direction, this also offers an advantage when accelerating the crankshaft during a restart in the same direction of travel.

The invention relates primarily to drive systems comprising single cylinder and multiple cylinder engines, wherein internal combustion engines that operate on the basis of the two-stroke cycle or the four-stroke cycle may be used; these may be Otto motors or diesel motors with intake manifold injection or direct injection.

In principle, the drive system of the invention may also encompass alternative drive units that run on alternative sources of energy such as natural gas, bio-gas, ethanol, methanol, hydrogen or electrical power or that are designed based upon alternative concepts, such as a gas turbine, in which flow energy from hot fresh gases is utilized.

In the drive system of the invention, an internal combustion engine designed as a four-stroke engine is preferably used; this engine is equipped with a variable valve drive for at least one intake valve and one exhaust valve of the associated cylinder. The valve train, which must be separate from the crankshaft for realization of a change in the rotational direction of the crankshaft, is preferably electromechanically actuated, however, wherein pneumatic or hydraulic designs are also possible.

The transmission for the above-described drive system can be advantageously designed without a reversing assembly, wherein any type of transmission may be used, i.e., a manual transmission, a double-clutch transmission, a stepped automatic transmission or a continuously variable automatic transmission.

If the transmission is designed as a manual transmission or a stepped automatic transmission with a pump and/or starter element that operates independent of the rotational direction, in one advantageous embodiment of the transmission, at least some of the forward gears that are assigned one rotational direction for the engine can represent reverse steps after a change in rotational direction for the engine. In this manner several reverse gears, e.g., for winter driving, can be realized while in the most extreme cases as many reverse gears as forward gears may be provided. Keeping assembly costs the same, however, it is also possible to include an additional forward gear, since the space that is ordinarily used for the reversing assembly is omitted.

In the event that the transmission is designed as a continuously variable automatic transmission, then the reversing components, the planetary gear set, and the brakes, which are necessary for the reversal in rotational direction and which require large amounts of space, can be omitted.

Additional advantages and further developments of the invention are found in the patent claims and in the exemplary embodiments described in principle below, with reference to the attached diagrams. The diagrams show:

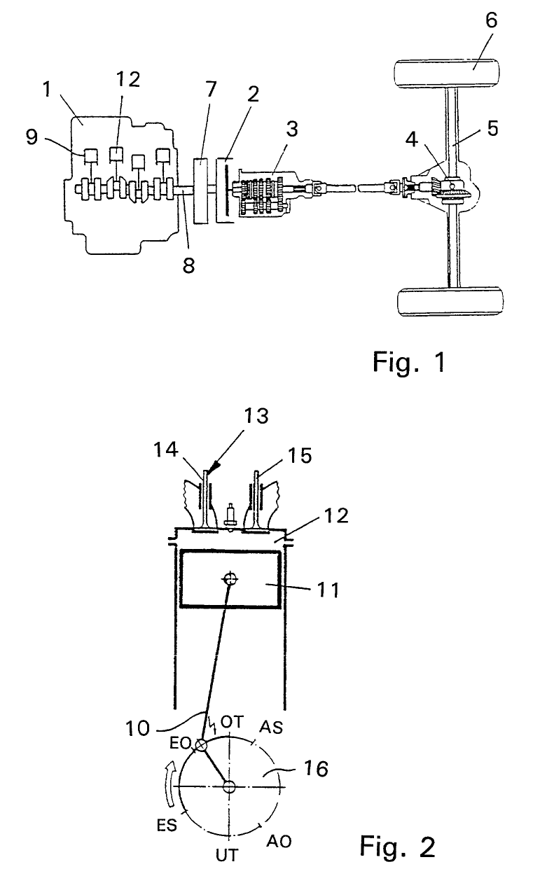

FIG. 1 is a simplified, schematic illustration of a power train, as specified in the invention, powered by a four-stroke internal combustion engine;

FIG. 2 is a schematic illustration of a compression cycle for a piston-cylinder unit in an internal combustion engine, as illustrated in FIG. 1, with a highly simplified activation diagram in which the processes that take place within the combustion chamber are plotted circularly according to the degree of rotation of the crankshaft rotations;

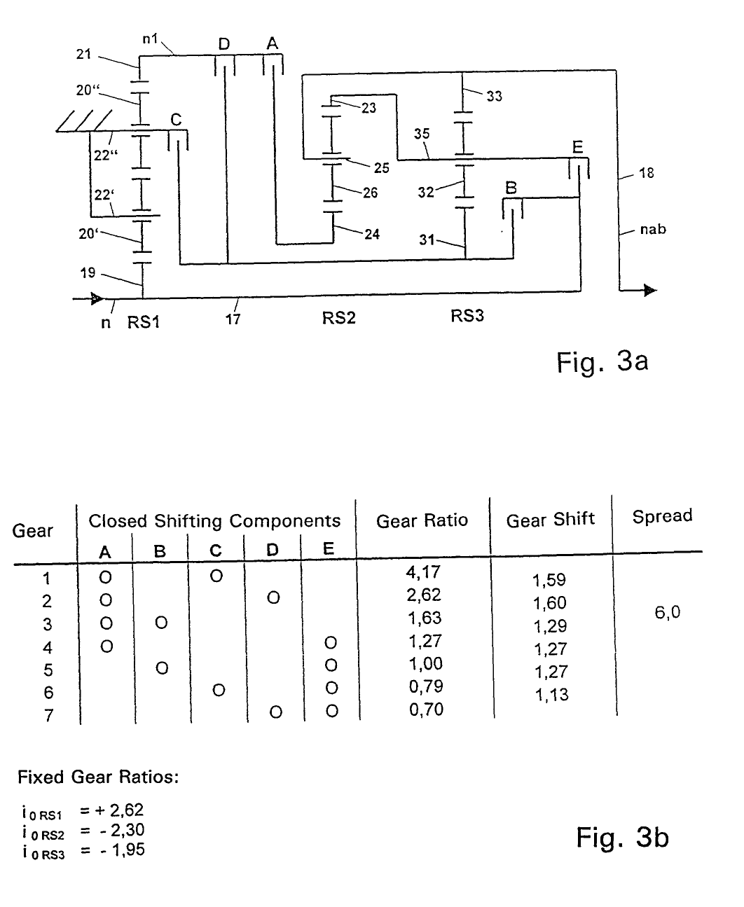

FIG. 3a is a transmission model for a first exemplary embodiment of a stepped automatic transmission for the power train system as shown in FIG. 1;

FIG. 3b is a clutch logic for the transmission illustrated in FIG. 3a;

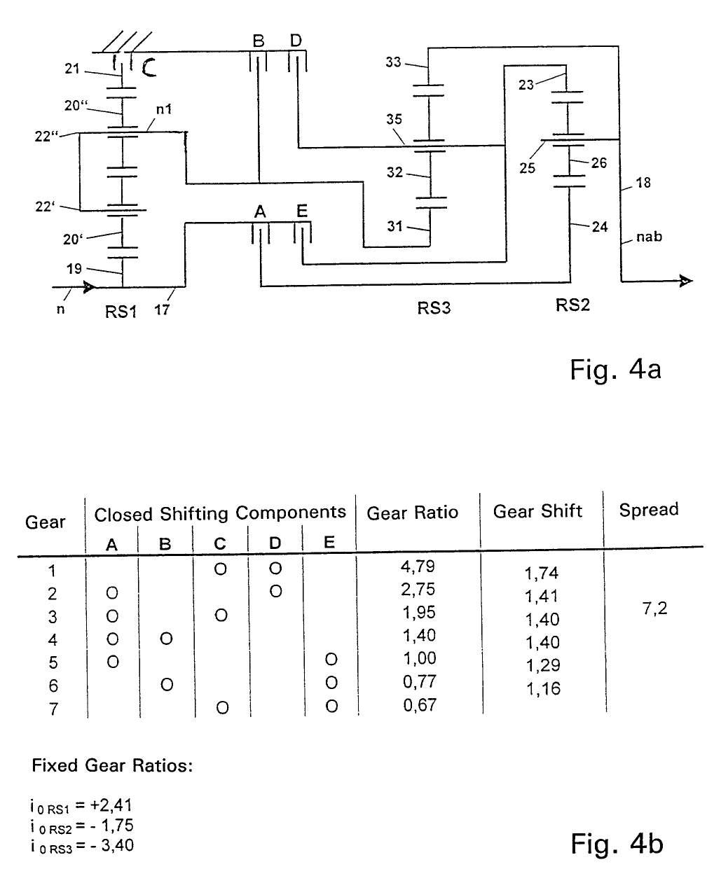

FIG. 4a is a transmission model for a second exemplary embodiment of a stepped automatic transmission as the transmission for the power train system shown in FIG. 1;

FIG. 4b is a clutch logic for the transmission in FIG. 4a;

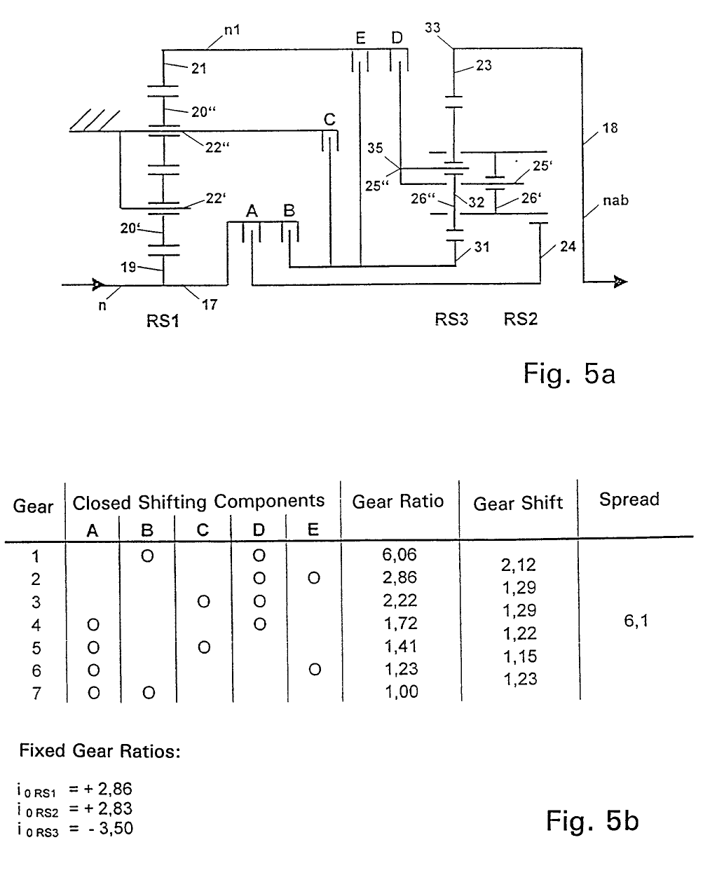

FIG. 5a is a third embodiment of a stepped automatic transmission which may be used as the transmission in the power train system shown in FIG. 1;

FIG. 5b is a clutch logic for the transmission in FIG. 5a;

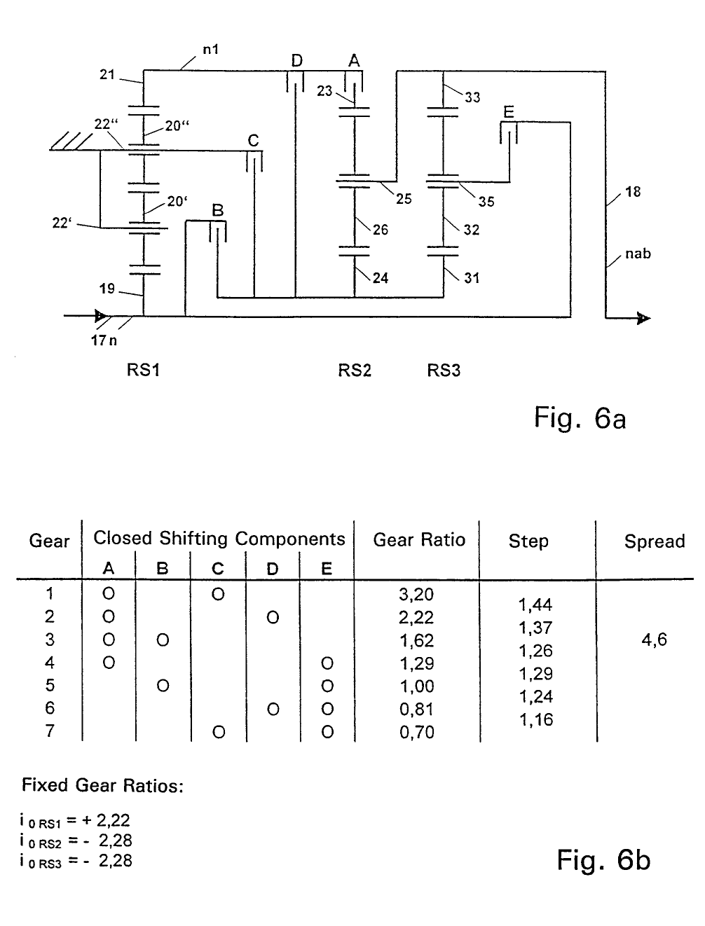

FIG. 6a is a clutch logic for the transmission for the power train systems shown in FIG. 1

FIG. 6b is a clutch logic for the transmission shown in FIG. 6a;

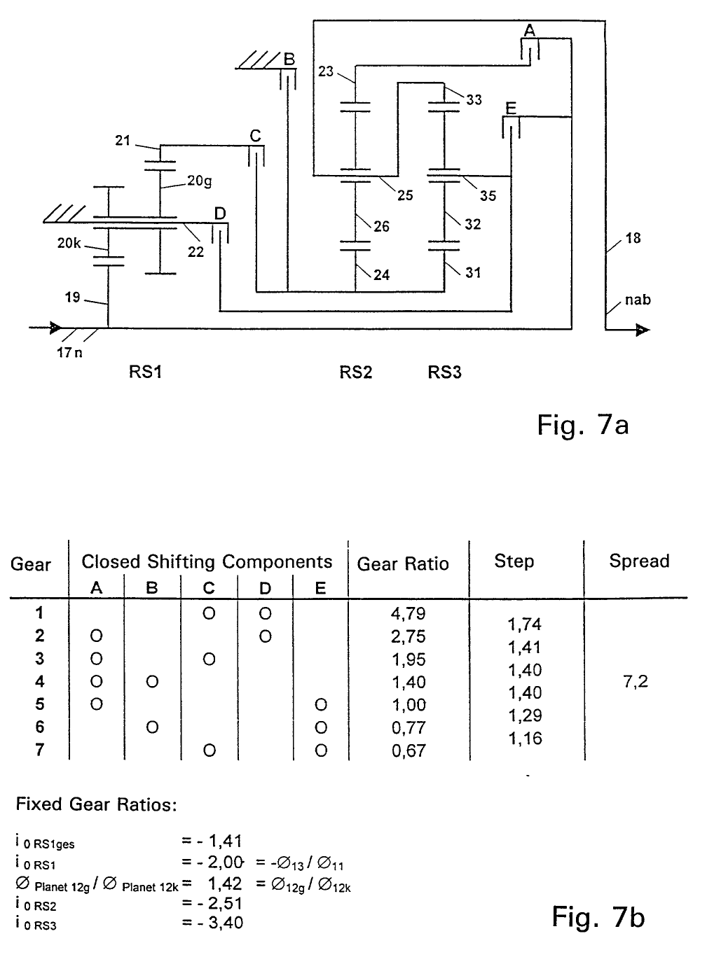

FIG. 7a is a further alternative embodiment of a transmission for use in the power train system shown in FIG. 1;

FIG. 7b is a clutch logic for the transmission introduced in FIG. 7a;

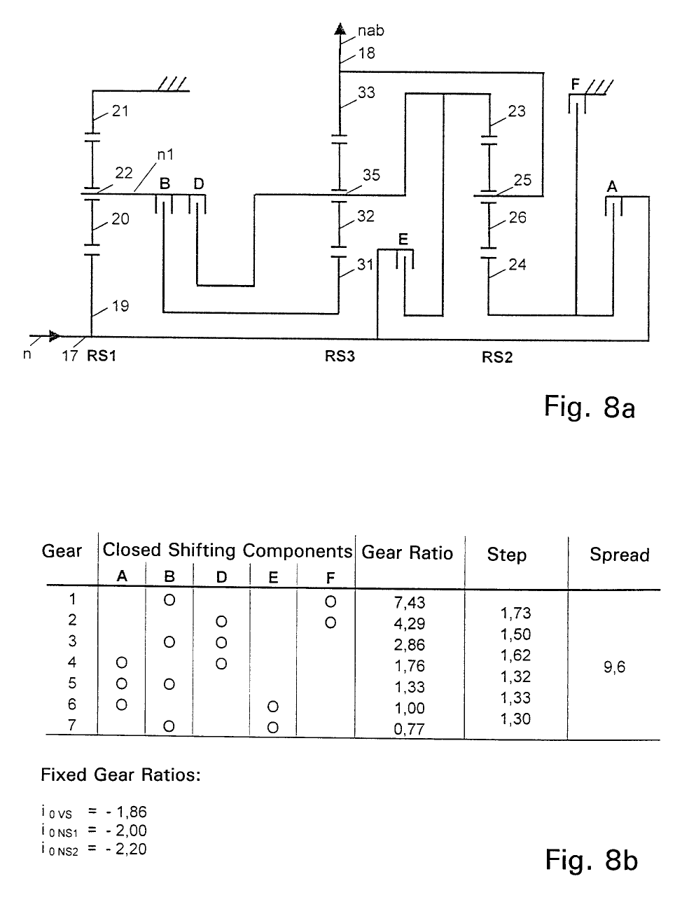

FIG. 8a is a transmission model for an eighth exemplary embodiment of a stepped automatic transmission as the transmission for the power train system shown in FIG. 1;

FIG. 8b is a clutch logic for the transmission in FIG. 8a;

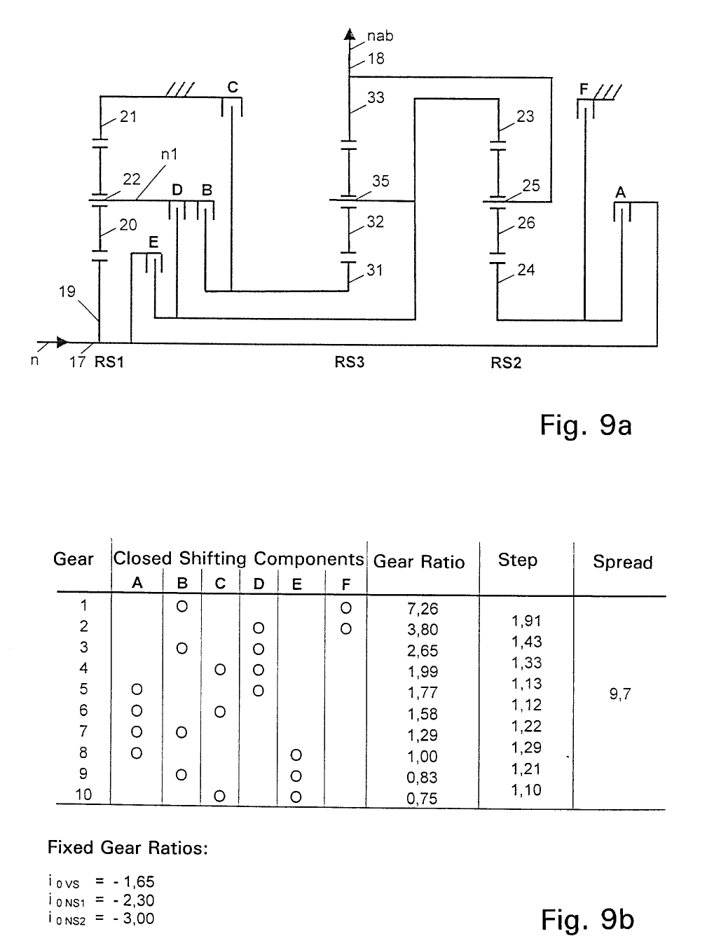

FIG. 9a is a ninth embodiment of a stepped automatic transmission that can be used as the transmission in the power train system shown in FIG. 1;

FIG. 9b is a clutch logic for the transmission in FIG. 9a;

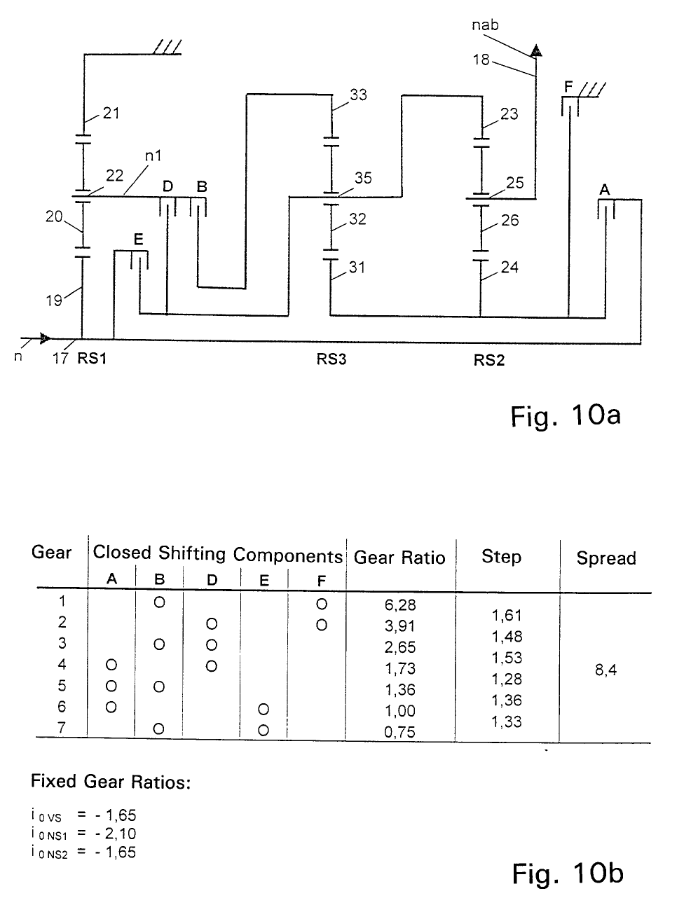

FIG. 10a is a further embodiment of a transmission for the power train system shown in FIG. 1;

FIG. 10b is a clutch logic for the transmission shown in FIG. 10a;

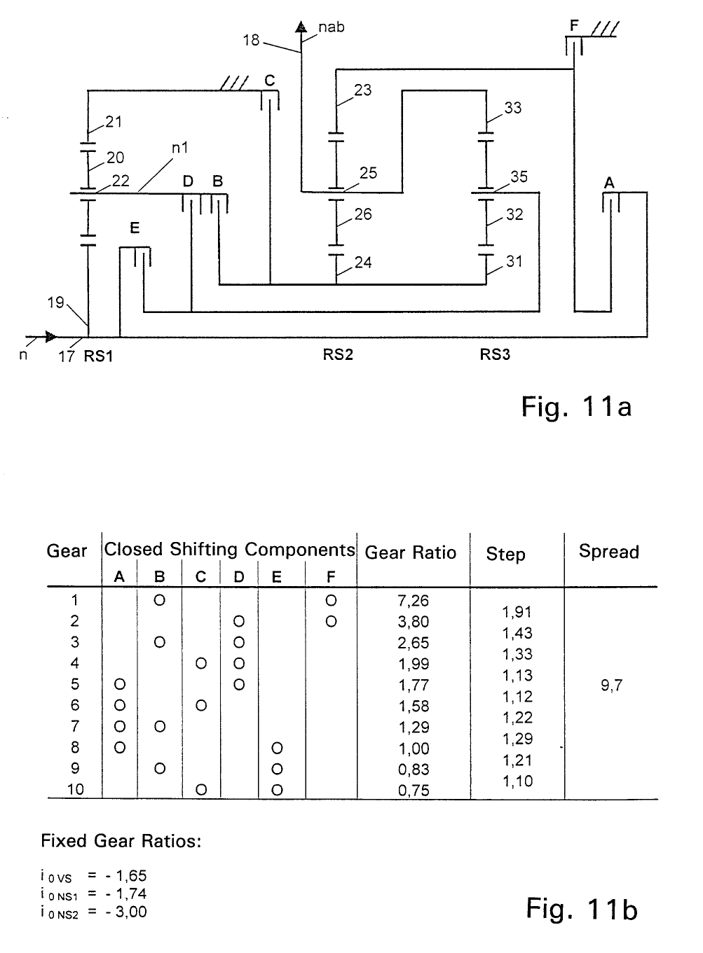

FIG. 11a is a further alternative construction of a transmission for use in the power train system shown in FIG. 1; and

FIG. 11b is a clutch logic for the transmission introduced in FIG. 11a.

FIG. 1 shows a highly schematized illustration of a power train system comprising a drive unit 1, in this case a four-cylinder, four-stroke internal combustion engine, a clutch 2, a transmission 3 for converting the torque generated by the drive unit 1 and transmitting it, via a drive shaft, and a differential 4 to a rear axle shaft 5 and to the drive gear 6 of the motor vehicle, which is connected to the rear axle shaft.

Between the internal combustion engine 1 and the clutch 2, an electrical device 7 is outlined; this device is connected to a crankshaft 8 in the internal combustion engine 1 and serves as the starter/generator. The electrical device 7 is designed such that when the engine is started, the device is capable of raising the necessary starting force to the starting speed necessary to directly power the crankshaft. In this, the electrical device 7 can be operated in two opposite rotational directions, wherein it powers the crankshaft 8 in one rotational direction to generate the torque necessary for a forward gear and in the opposite rotational direction to generate the torque necessary for a reverse travel. With its configuration as a generator, in the present case the electrical device 7 also performs the deceleration of the rotational movement of the internal combustion engine 1 prior to a change in rotational direction for the drive unit 1 and/or the crankshaft 8.

In the exemplary embodiment shown in FIG. 1, the internal combustion engine 1 comprises four cylinders 9 which, in each case with a piston 11 as in FIG. 2, is more apparently connected to a crank drive 10, as illustrated in detail in FIG. 2, form the boundary for a combustion chamber 12.

For example, the time and the duration of the intake of fresh gases and the time and duration of the emission of exhaust gases, the motor control is implemented via a variable valve drive 13, which comprises an intake valve 14 and an exhaust valve 15, in addition to a control electronic system that is not represented here in great detail, for the combustion chamber 12. The valve drive 13 is separate from the crankshaft 8 and in the present embodiment is electromechanically drive, so that advantageously a costly configuration for the valve drive, which must be able to run in both rotational directions of the crank shaft 8 and/or the internal combustion engine 1, is unnecessary.

The activation of the internal combustion engine 1 is dependent upon a control diagram 16, which is illustrated in a highly simplified form in FIG. 1, plotted on the basis of the degree of revolution of the crankshaft rotations. The control diagram 16 is designed to be axially symmetrical between upper dead center OT and lower dead center UT for the piston 11 in the cylinder 9. In this control diagram 16, the opening and closing times for the intake valve 14 and the exhaust valve 15 can be plotted based upon the degree of revolution of the crankshaft, as is demonstrated by way of example in the timing diagram 16 by the time ES for “close intake valve”, the time EO for “open intake valve”, the time AS for “close exhaust valve” and the time AO for “open exhaust valve”.

In FIG. 2, the compression stage in the working cycle that is comprised of the phases “intake”, “compression”, “operation”, and “emission” for the internal combustion engine 1 is illustrated.

The change in rotational direction is introduced via a well-calculated build-up of pressure brought on by closing the intake valves 14 and exhaust valves 15 of the cylinders 9; during the last half revolution of the crankshaft, prior to the change in rotational direction, the pistons 11 are in an upward motion. Thus the closing takes place at the point at which the pistons have passed through lower dead center UT.

The reversal in rotational direction optimally occurs at the point of maximum pressure build-up, i.e., generally when the first piston(s) has (have) reached upper dead center OT. Following the reversal in rotational direction, the closed intake valves 14 and exhaust valves 15 open up at the point at which pressure has completely dissipated, i.e., generally when the piston(s) has (have) reached lower dead center. Following a change in rotational direction, the valve strokes for the intake valve 14 and the exhaust valve 15 become mirror-inverted from their movement during the former direction of rotation of the crankshaft 8 with the timing of the valve train 13 changing correspondingly.

In terms of the control diagram 16, this means that the axis between upper dead center OT and lower dead center UT for the piston 9 forms a mirror axis, in mirror inversion to which the processes in the combustion chamber 12 during a change in rotational direction of the crankshaft 8 take place.

Turning now to the transmission side configuration for the power train system of the invention, a number of possible embodiments for a transmission 3 that is designed as a seven-gear stepped automatic transmission are presented in FIGS. 3a through 11b.

For instance, the transmission diagram illustrated in FIG. 3a shows a first embodiment of the transmission 3, in which a sun wheel 19 of a first planetary gear set RS1 is connected to a drive shaft 17 that runs at a speed n. A bar 22′ for the inner planet gears 20′ of the first planetary gear set RS1 is fixed and is coupled to a bar 22″ for the outer planet gears 20″ of the first planetary gear set RS1. Further, the drive shaft 17 can be connected to a bar 35 of a third planetary gear set RS3 via a shifting component E, wherein the bar 35 is connected to an internal gear 23 of the second planetary gear set RS2. In addition, the drive shaft 17 can be connected to a sun wheel 31 of the third planetary gear set RS3 via a shifting component B. The sun wheel 31 can be connected, and thus fixed, to the coupled and fixed bars 22′ and 22″ for the inner and/or outer planet gears 20′ and 20″ of the first planetary gear set RS1, via a shifting component C. The internal gear 21 of the first planetary gear set RS1, which runs at a speed n1, can be connected to the sun wheel 31 via a shifting component D, and can be connected to the sun wheel 24 of the second planetary gear set RS2 via the shifting component A. The internal gear 33 of the third planetary gear set RS3 is then connected to the bar 25 for the planet gears 26 of the second planetary gear set RS2 and to an output shift 18, which runs at a speed nab. The clutch logic for the transmission system shown in FIG. 3a is to be gathered in FIG. 3b.

In FIG. 4a, a further embodiment of the transmission 3 is schematically illustrated, which is comparable in terms of the number of gear sets and the number of shifting components with the embodiment in FIG. 3a. The drive shaft 17 is connected to the sun wheel 19 of the first planetary gear set RS1, and can be connected to the sun wheel 24 of the second planetary gear set RS2 via the shifting component A, and to the bar 35 for the planet gears 32 of the third planetary gear set RS3 via the shifting component E. The internal gear 21 of the first planetary gear set RS1 can be fixed via the shifting component C. The sun wheel 31 of the third planetary gear set RS3 is connected to the bar 22″ for the outer planet gears 20″ of the first planetary gear set RS1, which runs at a speed n1 and to the coupled bar 22′ for the inner planet gears 20′ of the first planetary gear set RS1. In addition, the sun wheel 31 can be fixed via the shifting component B. The bar 35 for the planet gears 32 of the third planetary gear set RS3 and the internal gear 23 of the second planetary gear set RS2 are connected and can be fixed via the shifting component D. The bar 25 for the planet gears 26 of the second planetary gear set RS2, the internal gear 33 of the third planetary gear set RS3, and the transmission output shaft 18, which runs at a speed nab, are connected to one another.

The special feature of this transmission, which operates on the basis of the clutch logic shown in FIG. 4b, is that this embodiment for the seven forward gears has two clutches and three brakes, instead of the configuration according to FIG. 3a of four clutches and one brake which, for example, with respect to pressure oil feed for activating it, can have a simpler structural configuration.

With the selective engagement of the shifting components, the forward gears 1 through 7 can be engaged in accordance with the shifting outline or clutch logic found in FIG. 4b.

The planetary gear set RS1 in the embodiment shown in FIG. 4a can also be implemented as a negative transmission with a stepped planet gear. In this embodiment, which is not illustrated here, the drive shaft 17 is connected to the sun wheel 19 of the first planetary gear set RS1 and the bar 22 for the coupled large and small planet gears can be fixed via the brake C. The sun wheel 31 of the third planetary gear set RS3 is connected to the internal gear 21 of the planetary gear set RS1. In this, the sun wheel 19 of the planetary gear set RS1 is engaged with the smaller planet gears of the planetary gear set RS1, while the large planet gears are engaged with the internal gear 21 of the planetary gear set RS1. In comparison with the planetary gear set RS1 of the embodiment shown in FIG. 4a, this embodiment offers the advantage of improved efficiency and a lower relative planetary speed.

FIG. 5a shows a further embodiment of the transmission 3 as a seven-gear, stepped automatic transmission, which is comparable with the previous constructions shown in FIGS. 3a and 4a with respect to the number of gear sets and the number of shifting components in the pre-shifting and post-shifting gear sets. The sun wheel 19 of the first planetary gear set RS1 and the bar 22″ for the outer planet gears 20″ of the first planetary gear set RS1 are coupled to one another and fixed. Furthermore, the drive shaft 17 can be connected to the sun wheel 24 of the second planetary gear set RS2 via the shifting component A, and to the sun wheel 31 of the third planetary gear set RS3 via the shifting component B. The bar 25″ for the outer planet gears 26″ of the second planetary gear set RS2 is connected to the bar 35 for the planet gears 32 of the third planetary gear set RS3 and to the bar 25′ for the inner planet gears 26″ of the second planetary gear set RS2. The planet gears 32 of the third post-shift planetary gear set RS3 and the outer planet gears 26″ of the second planetary gear set RS3 are combined. The sun wheel 31 of the third planetary gear set RS3, via the shifting component C, can be connected and thus fixed to the fixed bars 22″ and 22′ for the outer and/or inner planet gears 20″ and/or 20′ of the first planetary gear set RS1. The internal gear 21 of the first planetary gear set RS1, which rotates at the speed n1, can be connected to the sun wheel 31, via the shifting component E, and to the bar 35 for the planet gears 32 of the third planetary gear set RS3, via the shifting component D. The internal gear of the third planetary gear set RS3 and the internal gear 23 of the second planetary gear set RS2 are combined and connected to the output shaft 18.

These transmissions, which operate in accordance with the clutch logic shown in FIG. 5b, offer the special feature that in the highest gear the planetary gear sets RS2 and RS3 rotate in an interlocked state, causing the multiple stage transmission to possess a theoretical efficiency of 1 in the highest gear.

In FIG. 6a, another advantageous embodiment of the transmission 3 for the power train system specified in the invention is illustrated; this transmission operates on the basis of the clutch logic shown in FIG. 6b. In this embodiment, the sun wheel 19 of the first planetary gear set RS1 is connected to the drive shaft 17. The bar 22′ for the inner planet gears 20′ of the first planetary gear set RS1 is fixed and is coupled to the bar 22″ for the outer planet gears 20″ of the first planetary gear set RS1. The drive shaft 17 can be connected to the sun wheel 24 of the second planetary gear set RS2 and to the sun wheel 31 of the third planetary gear set RS3 that is coupled to the sun wheel 24, via the clutch B. The bar 35 for the third planetary gear set RS3 can be connected to the drive shaft 17 via the clutch E. In addition, the two sun wheels 24 and 31 of the second planetary gear set RS2 and the third planetary gear set RS3 can be connected and thus fixed to the coupled and fixed bars 22′ and 22″ for the first planetary gear set RS1 via the brake C. The internal gear 21 of the first planetary gear set RS1, which runs at the speed n1, can be connected to the sun wheel 31 of the third planetary gear set RS3, via the clutch D, and can be connected to the internal gear 23 of the second planetary gear set RS2 via the clutch A. The internal gear 33 of the third planetary gear set RS3 is connected to the bar 25 for the planet gears 26 of the second planetary gear set RS2 and to the output shaft 18.

The advantage of the embodiment of the transmission 3 illustrated in FIG. 6a and FIG. 6b over the embodiments shown in FIG. 3a and FIG. 4a consists in that only two shafts are nested inside one another rather than three. In comparison with the embodiments shown in FIGS. 3a, 4a and 5a, in this case the two planetary gear sets RS2 and RS3 can be implemented with the same gear ratio, thus the same components can be used, which can reduce the number of different parts required, thereby reducing overall cost.

The example in FIG. 6b depicts a low level of stepping—in comparison with the embodiments shown in FIGS. 3a through 5a- and thus a comparatively small spread. A stepping and spread that correspond to the above-named embodiments can be achieved with the proper adjustment to the fixed gear ratios of the three planetary gear sets.

In the further advantageous embodiment of the transmission 3 shown in FIG. 7a, the drive shaft 17 is connected to the sun wheel 19 of the planetary gear set RS1. The bar 22 for the coupled planetary gears 20g and 20k is fixed. In this, the sun wheel 19 of the first planetary gear set RS1 is engaged with the small planet gears 20k of the planetary gear set RS1, while the large planet gears 20g are engaged with the internal gear 21 of the planetary gear set RS1. The sun wheel 24 of the second planetary gear set RS2, and the sun wheel 31 of the third planetary gear set RS3 that is coupled to the sun wheel 24, can be fixed, via the brake B, and can be connected, via the clutch C, to the internal gear 21 of the first planetary gear set RS1. The bar 35 for the third planetary gear set RS3 can be connected to the drive shaft 17, via the clutch E, and can be fixed, via the brake D, that is attached to the fixed bar 22 for the planetary gear set RS1. The internal gear 23 of the second planetary gear set RS2 can be connected to the drive shaft 17 via the clutch A. The internal gear 33 of the third planetary gear set RS3 is connected to the bar 25 for the planet gears 26 of the second planetary gear set RS2 and to the output shaft 18.

As can be seen in the shifting logic shown in FIG. 7b, with a selective shifting of the five shifting components A through E, the forward gears 1 through 7 can be engaged. The embodiment in FIG. 7a combines the advantages of the above-described variation designed as a negative transmission and the embodiment shown in FIG. 4a and the advantages of the embodiment shown in FIG. 6a in terms of its efficiency and its construction costs.

On the basis of FIGS. 8a and 8b, a further advantageous embodiment of the transmission 3 for the power train system of the invention will now be detailed. In this embodiment, the drive shaft 17 is connected to the sun wheel 19 of the first planetary gear set RS1 and can be connected to the bar 35 for the planet gears 32 of the third planetary gear set RS3, via the clutch E, and can be connected to the sun wheel 24 of the second planetary gear set RS2 via the clutch A. The internal gear 21 of the first planetary gear set RS1 is fixed. The planet bar 22 for the planet gears 20 of the first planetary gear set RS1 can be connected to the sun wheel 31 of the third planetary gear set RS3, via the clutch B, and to the bar 35 for the third planetary gear set RS3 via the clutch D. The sun wheel 24 of the second planetary gear set RS2 can be fixed via the brake F. The bar 25 for the planet gear 26 of the second planetary gear set RS2 and the internal gear 33 of the third planetary gear set RS3 and the output shaft 18 are connected to one another.

With a selective shifting of the five shifting components, a total of seven forward gears can be engaged in accordance with the shifting logic depicted in FIG. 8b. This eighth embodiment of a stepped automatic transmission for the power train system, specified in the invention, is particularly well suited for use in a vehicle with front-transverse wheel drive.

FIG. 9a shows a ninth embodiment of the transmission 3 for the power train system specified in the invention. Proceeding from the eighth embodiment in FIG. 8a, described in detail above, the ninth embodiment has six shifting components A, B, C, D, E and F. The additional shifting component C over the eighth embodiment is designed as a brake and is positioned such that the sun wheel 31 of the third planetary gear set RS3 can also be fixed via this brake C.

As represented in FIG. 9b, this additional shifting component makes it possible to engage a total of ten forward gears. All three planetary gear sets are advantageously designed as negative transmission, which are favorable in terms of their construction costs. Like the eighth embodiment, this ninth embodiment of a stepped automatic transmission for the power train system specified in the invention is also especially well suited for use in a vehicle with front-transverse wheel drive.

FIG. 1a shows a further advantageous embodiment of the transmission 3 for the power train system specified in the invention. The key difference from the above-described eighth embodiment specified in the invention consists in the design of the planetary gear sets RS2 and RS3, now with coupled sun wheels 24 and 31. The internal gear 23 of the second planetary gear set RS2 is connected to the bar 35 for the third planetary gear set RS3. The design of the first planetary gear set RS1 corresponds to that of the above-described eighth embodiment as specified in the invention. The drive shaft 17 is connected to the sun wheel 19 of the first planetary gear set RS1. Furthermore, the drive shaft 17 can be connected to the coupled sun wheels 24 of the second planetary gear set RS2 and the sun wheels 31 of the third planetary gear set RS3, via the clutch A, and can be connected to the bar 35 for the third planetary gear set RS3 and to the internal gear 23 of the second planetary gear set RS2, which is connected to the bar 35, via the clutch E. The internal gear 21 of the first planetary gear set RS1 is fixed. The bar 22 for the first planetary gear set RS1 can be connected to the internal gear 33 of the third planetary gear set RS3 and the internal gear 23 of the second planetary gear set RS2, which is connected to this bar 35, via the clutch D. The connected sun wheels 24 and 31 of the second and third planetary gear sets RS2 and RS3 can be fixed via the brake F. The bar 25 for the second planetary gear set RS2 forms the output and is connected to the output shaft 18.

As represented in FIG. 10b, with a selective shifting of the shifting components A, B, D, E and F, a total of seven forward gears can be engaged without group shifting with a favorable gear-ratio step and a wide spread.

By way of example, an eleventh embodiment of a stepped automatic transmission for the power train system specified in the invention will be detailed below with reference to FIG. 11a. This eleventh embodiment comprises three planetary gear sets RS1, RS2 and RS3 and six shifting components A, B, C, D, E and F. As shown in FIG. 11a, the shifting components A, B, D, E are designed as a clutch and the shifting elements C, F are designed as the brake. The drive shaft 17 is connected to the sun wheel 19 of the first planetary gear set RS1 and can be connected to the internal gear 23 of the second planetary gear set RS2, via the clutch A. Further, the drive shaft 17 can be connected to the bar 35 for the planet gears 32 of the third planetary gear set RS3, via the clutch E. The internal gear 21 of the first planetary gear set RS1 is fixed. The sun wheel 24 of the second planetary gear set RS2 is connected to the sun wheel 31 of the third planetary gear set RS3. The internal gear 23 of the second planetary gear set RS2 can be fixed, via the brake F. The bar 22 for the planet gears 20 of the first planetary gear set RS1 can be connected to the sun wheel 24 of the second planetary gear set RS2 and to the connected sun wheel 31 of the third planetary gear set RS3, via the clutch B, and can be connected to the bar 35 for the third planetary gear set RS3, via the clutch D. The sun wheel 24 of the second planetary gear set RS2 and the sun wheel 31 of the third planetary gear set RS3, which is connected to the sun wheel 24, can be fixed via the brake C. The bar 25 for the planet gears 26 of the second planetary gear set RS2, the internal gear 33 of the third planetary gear set RS3 and the output shaft 18 are also connected to one another.

With a selective shifting of the six shifting components, a total of ten forward gears can be engaged without group shifting in accordance with the shifting logic depicted in FIG. 11b.

In one configuration of the ninth and eleventh embodiments of the transmission 3 it can also be provided for only nine forward gears to be engaged, rather than the possible ten, omitting the fifth gear illustrated in FIG. 9b and FIG. 11b. The gear stepping of this nine-gear transmission is quite harmonious.

In a further development of the eighth and/or ninth and/or tenth and/or eleventh embodiment of a stepped automatic transmission for the power train system specified in the invention, it is proposed that the first planetary gear set RS1 be designed as a positive transmission with a sun wheel 19, an internal gear 21 and two coupled bars 22′, 22″ with inner and outer planet gears 20′, 20″. In this embodiment, which is not illustrated here, the coupled bars 22′, 22″ of the first planetary gear set RS1 are fixed (in place of its internal gear 21) and the clutch shifting components B and D are connected to the internal gear 21 of the first planetary gear set RS1 (rather than to its bar).

All of the illustrated embodiments for the transmission 3 are suitable for use with the power train system specified in the invention in accordance with FIG. 1, in which the engine 1 and the electrical device 7 can be operated in two different rotational directions.

Reference numbers

| A | shifting component (clutch or brake) of the planetary gear set |
|---|---|
| AO | opening time for the exhaust valve |
| AS | closing time for the exhaust valve |
| B-D | shifting components (clutch or brake) of the planetary gear set |
| EO | opening time for the intake valve |
| ES | closing time for the intake valve |
| n | input rotational speed for the drive shaft |
| n1 | output rotational speed for the first planetary gear set RS1 |
| nab | output rotational speed |
| OT | upper dead center |
| RS1 | first planetary gear set |
| RS2 | second planetary gear set |
| RS3 | third planetary gear set |
| UT | lower dead center |
| 1 | drive, internal combustion engine |
| 2 | clutch |
| 3 | transmission |
| 4 | differential |
| 5 | rear axle shaft |
| 6 | drive gears |
| 7 | electrical device, starter/generator |
| 8 | crankshaft |
| 9 | cylinder |
| 10 | frank drive |
| 11 | piston |
| 12 | combustion chamber |
| 13 | valve drive |
| 14 | intake valve |
| 15 | exhaust valve |
| 16 | control diagram |
| 17 | drive shaft |
| 18 | output shaft |
| 19 | sun wheel for the first planetary gear set RS1 |
| 20 | planet gear for the first planetary gear set RS1 |
| 20′ | inner planet gear of the first planetary gear set RS1 |
| 20″ | outer planet gear of the first planetary gear set RS1 |
| 20k | small planet gear of the gear set RS1 |
| 20g | large planet gear of the gear set RS1 |
| 21 | internal gear of the first planetary gear set RS1 |
| 22 | bar for the planet gears of the first planetary gear set RS1 |
| 22′ | bar for the inner planet gears of the first planetary gear set RS1 |
| 22″ | bar for the outer planet gears of the first planetary gear set RS1 |
| 23 | internal gear of the second planetary gear set RS2 |
| 24 | sun wheel for the second planetary gear set RS1 |
| 25 | bar for the second planetary gear set RS2 |
| 25′ | bar for the inner planet gears of the second planetary gear set RS2 |
| 25″ | bar for the outer planet gears of the second planetary gear set RS2 |
| 26 | planet gear for the second planetary gear set RS2 |
| 26′ | inner planet gear of the second planetary gear set RS2 |
| 26″ | outer planet gear of the second planetary gear set RS2 |
| 31 | sun wheel of the third planetary gear set RS3 |
| 32 | planet gear of the third planetary gear set RS3 |
| 33 | internal gear of the third planetary gear set RS3 |
| 35 | bar for the third planetary gear set RS3 |

1. Drive system for a motor vehicle powered by a drive unit (1), and comprising a clutch (2) and a transmission (3) for transmitting and converting torque generated by the engine (1) to the drive gear (6) of the motor vehicle, wherein an electrical device (7) that can be operated as a motor is provided as the starter, characterized in that both the electrical device (7) and the drive unit (1) are capable of generating torque in one rotational direction and in the opposite rotational direction.

2. Drive system in accordance with claim 1, characterized in that the electrical device (7) can be operated as a motor and as a generator.

3. Drive system in accordance with claim 2, characterized in that the deceleration of the rotational movement of the drive unit (1) prior to a change in rotational direction is accomplished via a braking of the electrical device (7) by the generator.

4. Drive system in accordance with one of the claims 1 through 3, characterized in that the drive unit comprises an internal combustion engine (1), in which a combustion chamber (12) is delimited in a cylinder (9) by a piston (11) that is connected to a crank drive (10), wherein the timing of the internal combustion engine (1) is dependent upon information as to the position of a crankshaft.

5. Drive system in accordance with claim 4, characterized in that the timing of the internal combustion engine (1) is based upon a control diagram (16), in which the processes within the combustion chamber (12) are plotted around a circle based upon the degree of revolution of the crankshaft, wherein the axis between upper dead center (OT) and lower dead center (UT) for the piston (11) forms an inverted axis; with a change in the rotational direction of the crankshaft (8), the activation of the processes within the combustion chamber (12) becomes mirror-inverted to this axis.

6. Drive system in accordance with one of the claims 1 through 5, characterized in that when the drive unit (1) is disengaged to allow a change in rotational direction, a ring back in the opposite rotational direction by the crankshaft (8) is utilized to accelerate the change in rotational direction.

7. Drive system in accordance with claim 6, characterized in that the backward swing, the activation of the processes in the combustion chamber (12) and the electrical device (7) are synchronized with one another such that the crankshaft (8) passes through a rotational speed zero line at a specified angle.

8. Drive system in accordance with claim 7, characterized in that the synchronization is such that the crankshaft (8) passes through the rotational speed zero line at the point of maximum pressure build-up in the combustion chamber (12).

9. Drive system in accordance with one of the claims 4 through 8, characterized in that the internal combustion engine (1) is designed as a four-stroke engine with a variable valve drive (13) for at least one intake valve (14) and one exhaust valve (15) of the associated cylinder (9), wherein the valve train (13) operates separately from the crankshaft (8).

10. Drive system in accordance with claim 9, characterized in that the valve drive (13) is actuated electromechanically.

11. Drive system in accordance with claim 9, characterized in that the valve drive (13) is executed pneumatically or hydraulically.

12. Transmission for a drive system in accordance with one of the claims 1 through 11, characterized in that it is free from reversing assemblies.

13. Transmission in accordance with claim 12, characterized in that it is a manual transmission, a double-clutch transmission, a stepped automatic transmission (3) or a continuously variable automatic transmission.

14. Transmission in accordance with claim 12 ro 13, characterized in that at least some of the forward gears to which a rotational direction of the engine (1) is assigned, represent reverse gears after a change in rotational direction for the engine (1).
